(19) United States
(12) Patent Application Publication
(10) Pub. No.: US 2024/0151287 A1
(43) Pub. Date: May 9, 2024

(54) METHOD OF ESTIMATING WEAR OF A VEHICLE BRAKE ELEMENT

(71) Applicant: ITT ITALIA S.R.L., Lainate (IT)

(72) Inventors: Pietro Roberto Macchi, Torino (IT); Stefano Serra, Saluzzo (IT); Marco Terranova, Torino (IT); Umberto Vignolo, Porte (Torino) (IT)

(21) Appl. No.: 18/281,194

(22) PCT Filed: Mar. 9, 2022
(86) PCT No.: PCT/EP2022/055980

§ 371 Date: Sep. 8, 2023

(30) Foreign Application Priority Data
Mar. 10, 2021 (IT) 102021000005636

(51) Int. Cl. F16D 66/02

(52) U.S. Cl. CPC F16D 66/027; F16D 2066/001

(57) ABSTRACT

A method of estimating wear of a vehicle brake element including at least a braking disk (10), a wearable block of friction material (20) and a support back plate (40) of the block of friction material (20), comprising at least: —providing a temperature sensor (100) configured and placed to sense the temperature of the support back plate (40) —providing an Electronic Processing Unit (200) connected to the temperature sensor (100); —providing an acquisition of the sensed temperature of the support back plate (40), a generation of a temperature signal of the sensed temperature and a transmission of the temperature signals to the Electronic Processing Unit (200); —and the Electronic Processing Unit (200) providing an estimation (500) of the thickness of the wearable block of friction material (20) by processing of the temperature signals.

### BACKGROUND

The following disclosure relates to a method of estimating wear of a vehicle brake element.

### SUMMARY

Vehicle brake element's wear sensors have been on the market for a long time and are well-known devices.

Vehicle brake element's wear sensors of well-known type can be identified by their main operation principle as electric wear sensors and mechanical wear sensors.

Electric wear sensors operation principle lies on resistor circuits, which when the thickness of the brake element—typically a pad of a disk brake—decreases, make contact between the metallic disk and a sensitive area or interrupts the electric circuit and send a warning signal; more than a circuit can be provided at different depths of the pad, the warning signals so being processed by the vehicle's information center to calculate the remaining brake pad life.

Two main versions of the electric wear sensors are on the market: embedded in brake pads, and a separate sensor mounted to the brake pad and designed to maintain frictional contact with the brake rotor surface.

Mechanical wear indicators relay on modified backplate which generate a noise when the pad friction material level arrives to a designated reduced thickness.

Position sensors wear indicator measures the position of the brake mechanics and send a warning signal to the driver when a design position has been achieved.

Mixed operation systems wear sensors are also known and on the market.

Even EPB Electronic Parking Brake of a known type can detect pad wear by counting the number of screw/nut rotation needed to engage the rear brake pads: more rotations meaning lesser thickness of the pad.

Prior art U.S. Pat. No. 4,658,936A discloses an indicator for monitoring both the temperature and the degree of wear of a brake; U.S. Pat. No. 7,694,555 discloses a method for providing an estimate of brake pad thickness, employing fusion of sensors and driver brake modelling to predict the vehicle brake pad life through an algorithm.

U.S. Pat. No. 5,668,529A teaches a method to estimate the thickness of a brake lining based on the periodic sampling of the output of a temperature sensor embedded in the brake lining.

These traditional wear sensor are anyway complex items and highly subjected to heavy-duties stresses; temperature sensors embedded in the brake lining reach the very high temperature and pressure of the pad under the braking forces which concentrate on the sensor itself, and the pads themselves must be of a special and specific kind, with related costs.

The technical task described in the present disclosure is, therefore, to obviate current limitations of traditional wear sensors and improve their performances and reliability.

The technical task according to the present disclosure is achieved by providing a method of estimating wear of a vehicle brake element including at least a braking disk, a wearable block of friction material and a support plate of said block, characterized in that of comprising:
providing a temperature sensor configured and placed to sense the temperature of said support plate;
providing an electronic processing unit connected to said temperature sensor;
providing an acquisition of the sensed temperature of said support plate, a generation of a temperature signal of said sensed temperature and a transmission of said temperature signal to said electronic processing unit;
and said processing unit providing an estimation of the thickness of said block by processing of said temperature signal.

In an embodiment the temperature time variation of said temperature signal is processed to provide said estimation.

Said temperature sensor can be either a contact temperature sensor integrated in said support back plate or a contactless temperature sensor.

In an embodiment said temperature sensor is configured and placed to sense a temperature of a surface of said support back plate.

In an embodiment said surface is a surface of said support back plate facing to said wearable block of friction material.

In an embodiment said surface is a surface of said support back plate opposite to said wearable block of friction material.

In an embodiment said temperature sensor is configured and placed to sense a bulk temperature of said support back plate.

In an embodiment said acquisition is time based.

In an embodiment said acquisition is event based.

In an embodiment said event is a vehicle braking.

In an embodiment a number of vehicle braking are selected among those having same boundary conditions.

In an embodiment said estimation is in real time.

In an embodiment said method provides an ambient temperature sensor connected to said processing unit, acquires the ambient temperature, generates an ambient temperature signal of said ambient temperature, transmits said ambient temperature signal to said electronic processing unit, and said processing unit processes said ambient temperature signal to adjust said estimation. In an embodiment said method provides a vehicle accelerometer connected to said processing unit, acquires the acceleration, generates an acceleration signal of said acceleration, transmits said acceleration signal to said electronic processing unit, and said processing unit processes said acceleration signal to adjust said estimation and/or to select an event and/or to detect an event. In an embodiment said method provides a vehicle motion sensor connected to said processing unit, acquires the motion, generates a motion signal of said motion, transmits said motion signal to said electronic processing unit, and said processing unit processes said motion signal to adjust said estimation and/or to select an event and/or to detect an event.

In an embodiment said method provides said brake element with at least a force sensor connected to said processing unit, acquires the force, generates a force signal of said force, transmits said force signal to said electronic processing unit, and said processing unit processes said force signal to adjust said estimation and/or to select an event and/or to detect an event.

In an embodiment the force sensor includes a shear force sensor and/or a pressure force sensor.

In an embodiment said method provides providing a thermal model of said brake pad by creating a model of temperature dynamic correlated to a thickness of said block of friction material, and by making said estimation by selecting the model temperature dynamic that fits the measured temperature dynamic.

The present disclosure also provides a vehicle brake element including wearable block of friction material, a support back plate of said block of friction material, a temperature sensor configured and placed to detect the temperature of said support back plate, and an Electronic Processing Unit configured to carry out the above referred method of estimation of wear.

The present disclosure is focused on exploiting, when the vehicle is operative, the sensed temperature trend of the backplate of the braking element that has been found to be closely correlated to the current thickness of the friction block.

Indeed, when considering a braking event with same boundary conditions, as far as the thickness of the friction block decreases the time variation of the sensed temperature increases so that the backplate warms up quicker.

### BRIEF DESCRIPTION OF THE DRAWINGS

Various embodiments are depicted in the accompanying drawings for illustrative purposes and should in no way be interpreted as limiting the scope of this disclosure. Various features of different disclosed embodiments can be combined to form additional embodiments, which are part of this disclosure.

FIG. 1 schematically illustrates a layout of vehicle corner duly equipped with components for the method;

FIG. 2 schematically illustrates a method system architecture with smart brake pad sensors and time-based data acquisition;

FIG. 3 schematically illustrates a method system architecture with smart brake pad sensors and trigger-based data acquisition;

FIG. 4 schematically illustrates a method system architecture with trigger-based data acquisition;

FIG. 5 schematically illustrates a flow chart of the algorithm layout;

FIG. 6A, 6B, 6C graphics shown multiple events data acquisition algorithm strategy implementation;

FIG. 7A, 7B, 7C graphics shown single event data acquisition algorithm strategy implementation with comparison between new and worn brake pad;

FIG. 8 graphic shows experimental evidence of model based data acquisition algorithm strategy implementation.

FIG. 9A, 9B show experimental results.

### DETAILED DESCRIPTION OF CERTAIN EMBODIMENTS

In the following detailed description, reference is made to the accompanying drawings, which form a part hereof. In the drawings, similar reference numbers typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. The aspects of the present disclosure, as generally described herein, and illustrated in the figures, may be arranged, substituted, combined, and designed in a wide variety of different configurations, all of which are explicitly contemplated and made a part of this disclosure.

According to the present invention at least a braking element of a vehicle comprises a wearable block of friction material 20, a support back plate 40, and a temperature sensor 100 configured and placed to acquire the temperature of the support back plate 40.

The temperature sensor 100 is either a contact temperature sensor integrated in support back plate 40 or a contactless temperature sensor.

Furthermore the temperature sensor 100 can be configured and placed to sense either a temperature of a surface of the support back plate 40 or a bulk temperature of the support back plate 40.

For instance, the temperature sensor 100 can be placed on a surface of the support back plate 40 facing the wearable block of friction material 20.

The temperature sensor 100 can be integrated in the support back plate 40 and placed flush with the surface of the support back plate 40 facing the wearable block of friction material 20.

However, if temperature of a surface of the support back plate 40 is to be sensed, then said surface can be a surface of the support back plate 40 either facing to or opposite to the wearable block of friction material 20.

The temperature sensor 100 can a discrete component, or it can be directly screen printed on the metal support back plate; different layouts can be realized combining different types of sensors; multiple temperature sensors can be used to have distributed temperatures monitoring.

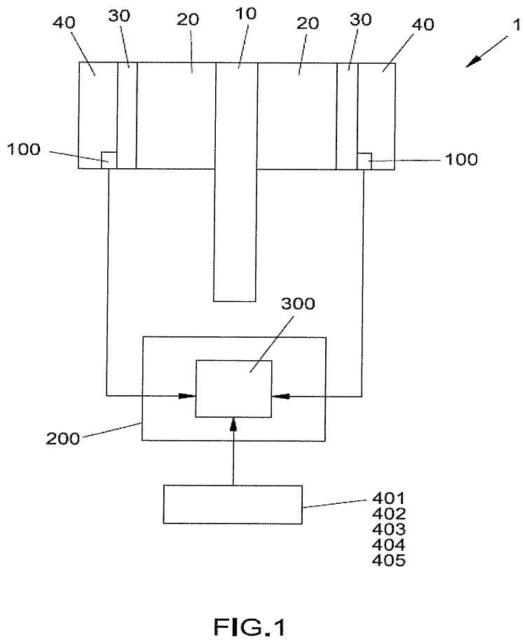

The braking element can be either a pad cooperating with a disk 10, as shown only by way of example in FIG. 1, or a clamp cooperating with a drum.

As schematically shown in FIG. 1, the vehicle corner 1 is duly equipped with a vehicle brake pad including an optional underlayer 30 between the wearable block of friction material 20 and the support back plate 40.

An Electronic Processing Unit (EPU) 200 is provided and connected to the temperature sensor 100; conveniently, the Electronic Processing Unit (EPU) 200 is also connected and receives input signals by a plurality of auxiliary sensors 401, 403, 404 on board of the vehicle.

Also force sensors 402 embedded into the brake pad, and a brake pedal switch 405 can be provided and connected to the Electronic Processing Unit 200.

Specifically, an Algorithm 300 according to the present method's invention supersedes to the Electronic Processing Unit (EPU) 200 data collection, elaboration, and outputs.

The method of estimating wear of a vehicle brake element according to the current invention provides an acquisition by the temperature sensors 100 of the sensed temperature on the support back plate 40, the generation of the temperature signals and the transmission of the temperature signals to the Electronic Processing Unit 200, which provides an estimation of the thickness of the wearable block of friction material 20 by duly processing the temperature signals through the algorithm 300.

In the following description text, Item 20 will be indifferently referred to as “wearable block of friction material” or “brake pad”; the term “brake pad temperature” is conventionally used for the “temperature on the back plate”.

According to the method disclosed by the present invention, brake pad 20 thermal dynamics, i.e. the temperature time variation of the brake pad temperature signal, will be used to estimate brake pad 20 wear.

Advantageously, seasonal adjustment is performed using measured ambient temperature to increase algorithm performances and resolution.

Advantageously, brake pad 20 wear estimation can be performed in real time.

Advantageously, the vehicle corner 1 can be equipped with one or two temperature sensors 100 where brake pad 20 wear can be estimated for each brake pad 20 or as a mean value of the brake pads 20 of the vehicle corner 1.

Advantageously, each vehicle corner 1 can be equipped with temperature sensors 100.

Advantageously, brake pad 20 wear calculation can be performed by an overall Electronic Processing Unit 200 or single Electronic Processing Units 200, each one of them dedicated to each vehicle corner 1.

### System Architectures

Three different system architectures will be disclosed in the following description, where each one of them can be implemented according to the data acquisition strategy chosen and auxiliary sensors used, and where all the architectures can be used with each one of the algorithm's strategies.

### Time-Based Data Acquisition Architecture.

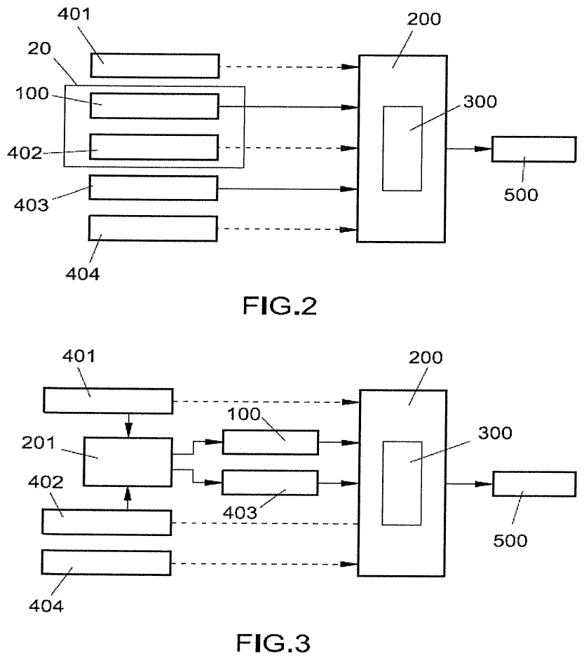

FIG. 2 schematically shows a method system architecture with time-based data acquisition.

The architecture at least includes temperature sensor 100, accelerometers 401, ambient temperature sensors 403, smart pad force sensors 402, motion sensors 404, and an Electronic Processing Unit 200 with the Algorithm 300.

Smart pad force sensors 402 include at least a shear force sensor and/or a pressure force sensor. All sensors data acquisitions are performed at time instants defined by the Electronic Processing Unit 200.

Typically, intervening period between data acquisition time instants is included between 20 second and 60 second, preferably 30 second.

Ambient temperature sensors 403 are used for seasonal adjustments of the data collected by the temperature sensors 100; other known tools that can detect environmental changes can be used for seasonal adaptation purposes.

An ambient temperature sensor 403 is connected to the Electronic Processing Unit 200, where the ambient temperature sensor 403 acquires the ambient temperature, generates an ambient temperature signal which is transmitted to the Electronic Processing Unit 200.

Accelerometers 401, smart pad pressure/shear sensors 402, and motion sensors 404 can be used or not to estimate brake pad 20 wear.

Accelerometers 401 are connected to the Electronic Processing Unit 200, where the accelerometer 401 acquires the vehicle acceleration as defined by the Electronic Processing Unit 200, generates a vehicle acceleration signal which is transmitted to the Electronic Processing Unit 200.

Smart pad force sensors 402 are connected to the Electronic Processing Unit 200, where smart pad force sensors 402 acquires at least a force as defined by the Electronic Processing Unit 200, generates a force signal which is transmitted to the Electronic Processing Unit 200.

Vehicle motion sensor 404 is connected to the Electronic Processing Unit 200, where the vehicle motion sensor 404 acquires the vehicle motion as defined by the Electronic Processing Unit 200, generates a motion signal which is transmitted to the Electronic Processing Unit 200. The collected data are processed by the Electronic Processing Unit 200 through the Algorithm 300; accelerometers' 401, smart pad force sensors' 402, vehicle motion sensors' 404 signals are processed to compensate ad to adjust the wear estimation and/or to select and/or to detect a significant event, namely a significant braking event.

Finally, a brake pad 20 wear estimation 500 is provided.

Trigger-Based Data Acquisition Architecture. First Example.

FIG. 3 schematically shows a method system architecture with smart brake pad sensors and with trigger-based data acquisition.

The architecture at least includes temperature sensor 100, accelerometers 401, ambient temperature sensors 403, smart pad force sensors 402, motion sensors 404, an Acquisition Strategy Unit 201, an Electronic Processing Unit 200 with the Algorithm 300.

In a trigger-based data acquisition strategy, data acquisition is performed only when a significant event, namely a significant braking event, occurs.

An Acquisition Strategy Unit 201 can be used for significant braking events selection among all the braking events as detected by accelerometers 401 and smart pad force sensors 402.

Motion sensors 404 can be used as well in the Acquisition Strategy for significant braking events selection.

Ambient temperature sensors 403 are used for seasonal adjustments of the data collected by the temperature sensors 100; other known tools that can detect environmental changes can be used for seasonal adaptation purposes.

Accelerometers 401, smart brake pad pressure/shear sensors 402, and motion sensors 404 can be used or not to estimate brake pad 20 wear.

The collected data are processed by the Electronic Processing Unit 200 through the Algorithm 300 and a brake pad 20 wear estimation 500 is provided.

Trigger-Based Data Acquisition Architecture. Second Example.

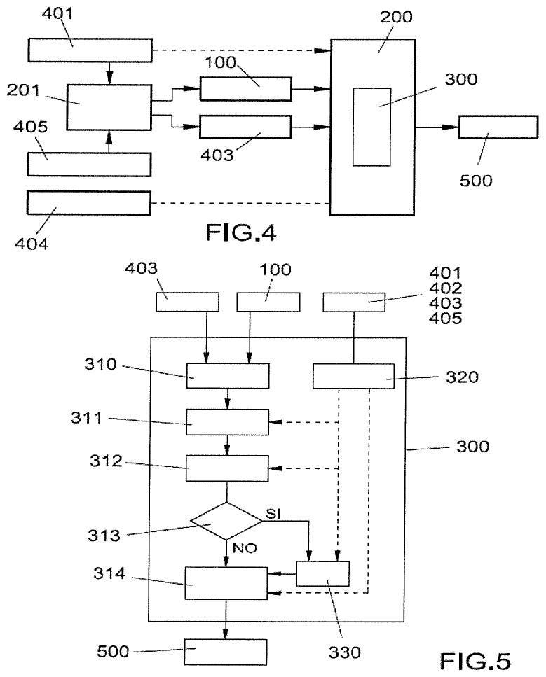

FIG. 4 schematically shows a method system architecture where smart brake pad force sensors are not provided, and with trigger-based data acquisition.

The architecture at least includes temperature sensor 100, accelerometers 401, ambient temperature sensors 403, brake pedal switch or vehicle network 405, motion sensors 404, an Acquisition Strategy Unit 201, an Electronic Processing Unit 200 with the Algorithm 300.

In a trigger-based data acquisition strategy, temperature sensors 100 data acquisition and ambient temperature sensors 403 data acquisition are performed only when a significant event, namely a significant braking event, occurs.

An Acquisition Strategy Unit 201 can be used for significant braking events selection among all the braking events as detected by accelerometers 401 and a brake pedal switch 405.

Motion sensors 404 can be used as well in the Acquisition Strategy for significant braking events selection.

Ambient temperature sensors 403 are used for seasonal adjustments of the data collected by the temperature sensors 100; other known tools that can detect environmental changes can be used for seasonal adaptation purposes.

Accelerometers 401, brake pedal switch 405, and motion sensors 404 can be used or not to estimate brake pad 20 wear.

The collected data are processed by the Electronic Processing Unit 200 through the Algorithm 300 and a brake pad 20 wear estimation 500 is provided.

### Algorithm Layout

Temperature selection criteria are based on the following principles: v: braking frequency (as time between two consecutive events);
T_{Abs}: minimum/maximum temperature and/or temperature variation;
T_{Buf}: minimum/maximum temperature and/or temperature variation inside selected buffer;
dTₚₒₛ: Temperature first derivative must be positive (heating conditions);
N_{ptiBrk}: number of events;
σT: temperature and/or temperature variation standard deviation based criteria;

FIG. 5 schematically shows a flow chart of the algorithm 300 layout in the Electronic Processing Unit 200.

Acquired data by the temperature sensor 100 are adjusted by seasonal adjustment section 310 by the ambient temperature signals transmitted by ambient temperature sensors 403.

Preliminary selection section 311 selects data based on temperature dynamics trend and/or braking events frequency and/or driving style collected by the auxiliary sensors 401, 402, 404, 405 and compensated by a sensor compensation section 320.

Wear index calculation section 312 acts by buffering and categorizing the data with adaptive logic and carries out a calculation of the wear index on categorized buffer data, then scales it using temperature sensor 100 and/or other auxiliary sensor 400 related functions.

In learning phase section 313 a choice is to be made: if current action is in a learning phase, definition of normalization factor is made in section 330 using statistical approach based on first data points; in this preliminary learning phase the wear index is calculated incrementally.

A self-learning phase allows to adapt the algorithm parameters to vehicle's models, brake pad part number and user's driving style: this allows to avoid different algorithm versions for different applications.

If current action is not in a learning phase, a wear estimation calculation section 314 acts by wear index filtering using adaptive thresholds and normalization; a data consistency check follows, and a wear estimation 500 is provided in real time.

### Algorithm Strategies

Data acquisition strategy can be, as seen above:
time based;
trigger based.

Conveniently, all the algorithms are independent from vehicle/brake pad models and driving style, so no tuning is due for different applications, thanks to:
a braking events selection strategy;
a self-learning phase when the brake pad is new.

Three different algorithm strategies can be used:
Multiple Events Strategy;
Single Event Strategy;
Model Base Strategy.

### Multiple Events Strategy:

brake pad 20 wear is estimated mapping the brake pad thermal dynamics between subsequent braking events, if in a trigger-based acquisition, or between subsequent acquisitions during vehicle operation, if in a time-based acquisition.

Single acquisition point has to be acquired for every acquisition request, both in a trigger-based and in a time-based strategy.

In a time-based strategy, all sensors data acquisitions are performed at time instants defined by the Electronic Processing Unit 200.

In time based strategy acquisition is synchronous with sample time for instance between 20s and 60 s preferably 30 s. Acquisition is performed during all vehicle operation.

In trigger based strategy acquisition is asynchronous and it is performed when the event occurs. Thermal dynamic to be considered for wear estimation is the one between different instants acquired during the vehicle operation.

Data acquisition point can be selected or cannot be selected in order to increase algorithm performances and resolution and possibly to avoid algorithm calibration for different vehicle/brake pad models and different driving style.

Events selection can be performed using the auxiliary sensors.

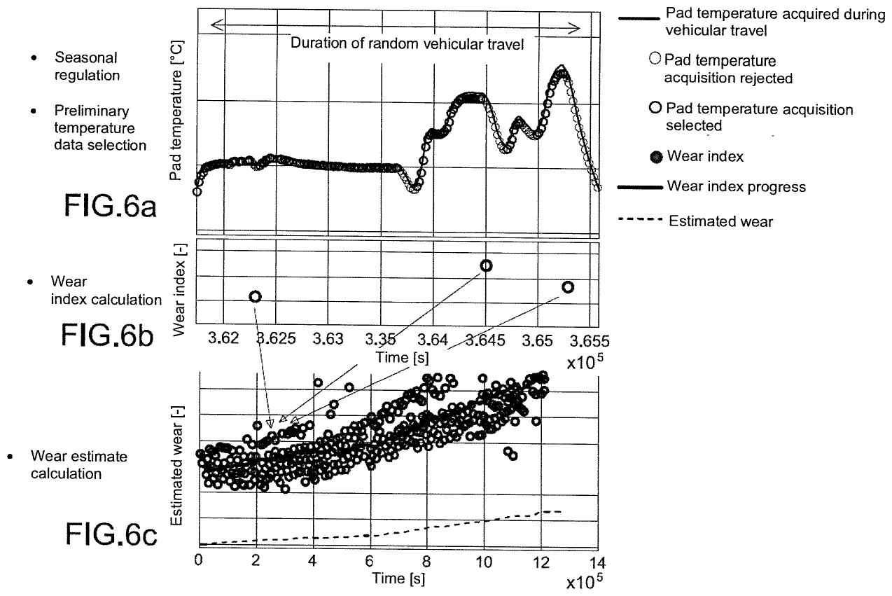

FIG. 6A, 6B, 6C graphics shown temperature acquired during a vehicle operation, selected brake pad temperature acquisition, wear index calculation and wear estimation calculation.

### Single Event Strategy:

brake pad 20 wear is estimated comparing the brake pad thermal dynamics during the braking event among selected different braking events with the same boundary conditions.

Data acquisition can be performed with trigger-based strategy.

Multiple acquisition points have to be acquired for a every/selected brake event in order to map the temperature evolution during the single event.

All sensors data acquisitions are performed at time instants defined by the Electronic Processing Unit 200.

Typically, intervening period between data acquisition time instants is included between 0.01 second and 2.0 second, preferably 0.10 second.

Thermal dynamic to be considered for wear estimation is the one between different instants acquired during the single brake event.

Braking events can or can not be selected in order to increase algorithm performances and resolution and possibly to avoid algorithm calibration for different vehicle/brake pad models and different driving style.

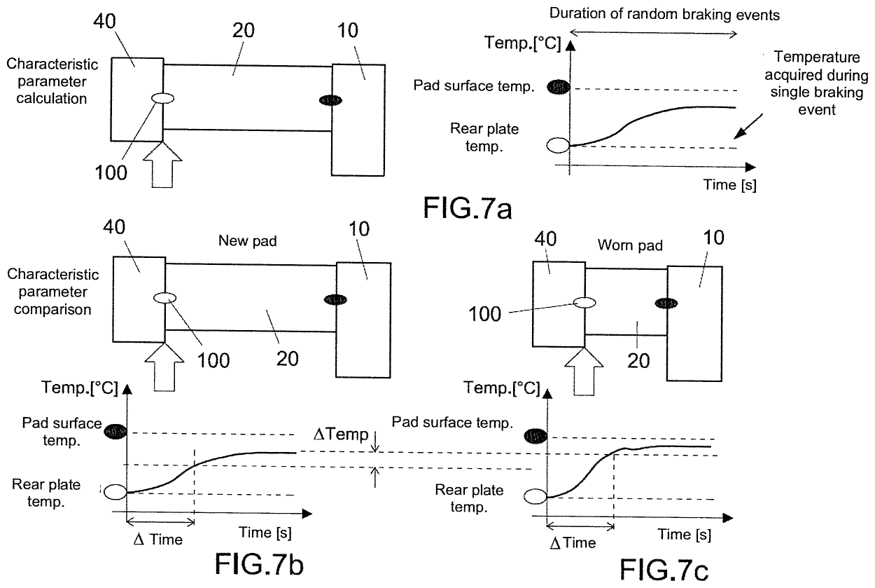

FIG. 7A, 7B, 7C graphics shown temperature acquired during a single braking event and characteristic parameters comparison.

### Model Base Strategy:

Brake pad 20 wear is correlated with measured brake pad thermal dynamics using a model-based approach.

A thermal model of the brake pad 20 is provided by creating a model of temperature dynamics correlated to a thickness of a brake pad.

The brake pad thickness for which the model temperature dynamics fits the measured one is considered to be the actual brake pad 20 thickness.

Boundary conditions of the braking event are estimated using the auxiliary sensors.

The algorithm can be applied to each braking event or only to some selected brake events, in order to increase algorithm performances and resolution, and possibility to avoid algorithm calibration for different vehicle/pad models and different driving style.

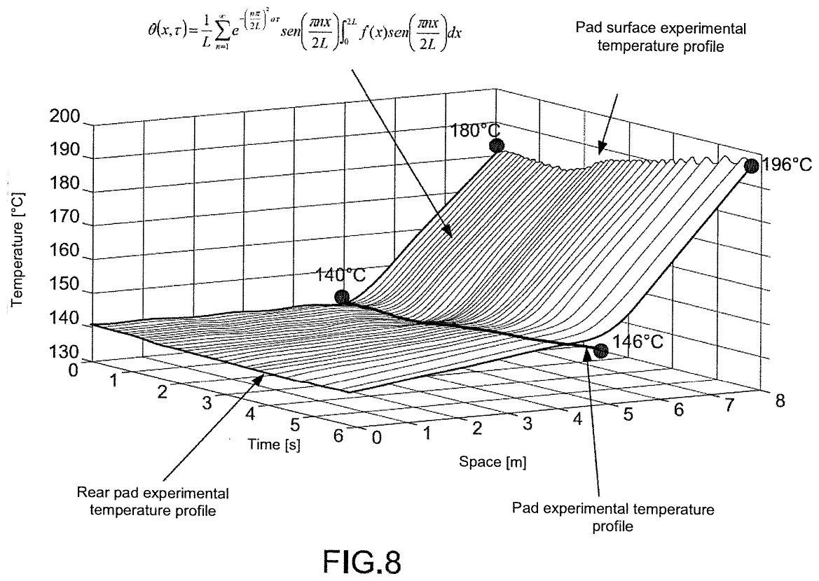

FIG. 8 graphic shows experimental evidence of model-based data acquisition algorithm strategy.

### EXPERIMENTAL RESULTS

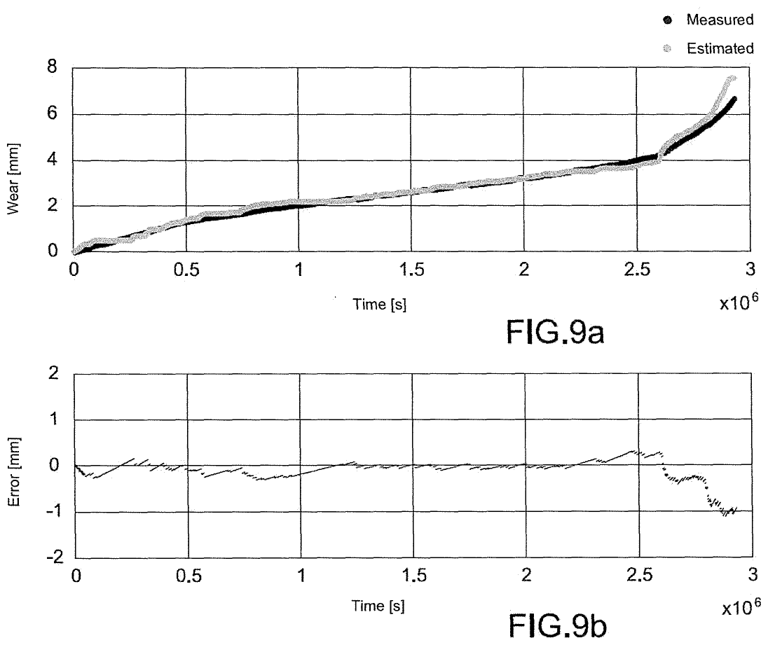

FIG. 9A, 9B show experimental results.

Experimental results show great correlation between measured brake pad wear and estimated brake pad wear according to the method disclosed by the present invention.

Modifications and variations in addition to those described are naturally possible; the method of estimating wear of a vehicle brake element thus conceived is susceptible to numerous modifications and variants, all of which fall within the scope of the inventive concept; further, all details may be replaced with other technically equivalent elements. In practice the materials used, as well as the systems, can be any according to the needs and the state of the art.

1. A method of estimating wear of a vehicle brake element including at least a braking disk, a wearable block of friction material and a support back plate of said block of friction material the method comprising:
providing a temperature sensor configured and placed to sense the temperature of said support back plate
providing an electronic processing unit connected to said temperature sensor;
providing an acquisition of the sensed temperature of said support back plate, a generation of a temperature signal of said sensed temperature and a transmission of said temperature signals to said electronic processing unit; and
said electronic processing unit providing an estimation of the thickness of said wearable block of friction material by processing of said temperature signals.

2. A method of estimating wear of a vehicle brake element according to claim 1, characterized in that temperature time variation of said temperature signal is processed to provide said estimation.

3. A method of estimating wear of a vehicle brake element according to claim 1, wherein said temperature sensor is a contact temperature sensor integrated in said support back plate.

4. A method of estimating wear of a vehicle brake element according to claim 1, wherein said temperature sensor is a contactless temperature sensor.

5. A method of estimating wear of a vehicle brake element according to claim 1, wherein said temperature sensor is configured and placed to sense a temperature of a surface of said support back plate.

6. A method of estimating wear of a vehicle brake element according to claim 5, wherein said surface is a surface of said support back plate facing to said wearable block of friction material.

7. A method of estimating wear of a vehicle brake element according to claim 5, wherein said surface is a surface of said support back plate opposite to said wearable block of friction material.

8. A method of estimating wear of a vehicle brake element according to claim 1, wherein the temperature sensor is configured and placed to sense a bulk temperature of said support back plate.

9. A method of estimating wear of a vehicle brake element according to claim 1, wherein said acquisition is time based.

10. A method of estimating wear of a vehicle brake element according to claim 1, wherein said acquisition is event based.

11. A method of estimating wear of a vehicle brake element according to claim 10, wherein said event is a vehicle braking event.

12. A method of estimating wear of a vehicle brake element according to claim 1, further comprising providing an ambient temperature sensor connected to said electronic processing unit, acquiring the ambient temperature, generating an ambient temperature signal of said ambient temperature, transmitting said ambient temperature signal to said electronic processing unit, and said electronic processing unit processing said ambient temperature signal to adjust said estimation.

13. A method of estimating wear of a vehicle brake element according to claim 1, further comprising providing a vehicle accelerometer connected to said electronic processing unit, acquiring the vehicle acceleration, generating an acceleration signal of said vehicle acceleration, transmitting said vehicle acceleration signals to said electronic processing unit, and said electronic processing unit processing said acceleration signal to adjust said estimation and/or to select an event and/or to detect an event.

14. A method of estimating wear of a vehicle brake element according to claim 1, further comprising providing a vehicle motion sensor connected to said electronic processing unit, acquiring the vehicle motion, generating a vehicle motion signal of said vehicle motion, transmitting said vehicle motion signals to said electronic processing unit, and said electronic processing unit processing said motion signals to adjust said estimation and/or to select an event and/or to detect an event.

15. A method of estimating wear of a vehicle brake element according to claim 1, further comprising providing said brake element with at least a force sensor connected to said electronic processing unit, acquiring the force, generating a force signal of said force, transmitting said force signals to said electronic processing unit, and said electronic processing unit processing said force signals to adjust said estimation and/or to select an event and/or to detect an event.

16. A method of estimating wear of a vehicle brake element according to claim 1, further comprising providing a thermal model of said brake pad by creating a model of temperature dynamic correlated to a thickness of said block, and by making said estimation by selecting the model temperature dynamic that fits the measured temperature dynamic.

17. A vehicle brake element including wearable block of friction material, a support back plate of said block of friction material, a temperature sensor configured and placed to detect the temperature of said support back plate, and an electronic processing unit configured to carry out a method according to claim 1.

18. A vehicle brake system comprising:
a wearable block of friction material;
a support back plate configured to support the block of friction material;
a temperature sensor configured to detect the temperature of the support back plate; and
an electronic processing unit configured to:
receive sensed temperature measurements generated by the temperature sensor;
process the temperature measurements to provide an estimation of the thickness of said wearable block of friction material.

19. Non-transitory computer readable media storing instructions that, when executed by a processor, cause the processor to execute a method comprising:
receiving sensed temperature measurements generated by a temperature sensor configured to detect the temperature of a support back plate that supports a wearable block of friction material of a vehicle braking element; and
process the temperature measurements to provide an estimation of the thickness of said wearable block of friction material.
